(19) United States
(12) Patent Application Publication
(10) Pub. No.: US 2013/0222309 A1
(43) Pub. Date: Aug. 29, 2013

(54) MOTOR DRIVE CIRCUIT

(71) Applicants: Weiming Sun, Beijing (CN); Qing Liao, Beijing (CN); Lei Huang, Beijing (CN)

(72) Inventors: Weiming Sun, Beijing (CN); Qing Liao, Beijing (CN); Lei Huang, Beijing (CN)

(21) Appl. No.: 13/780,559

(22) Filed: Feb. 28, 2013

(30) Foreign Application Priority Data
Feb. 28, 2012 (CN) 201210055777.9

(51) Int. Cl. G06F 3/01; H02P 31/00

(52) U.S. Cl. CPC G06F 3/016; H02P 31/00
USPC 345/173; 318/126

(57) ABSTRACT

This document discusses, among other things, apparatus and methods for a motor drive, such as a haptic motor drive. In an example, a motor drive can include a low dropout (LDO) regulator configured to receive a supply voltage and to provide a regulated voltage, a power switch circuit configured to receive the supply voltage and to receive the regulated voltage from the LDO regulator, and a level shift circuit configured to receive power from the power switch circuit, to receive an input signal, and to provide an output signal to a a voltage difference generating circuit based on the input signal and the power from the power switch circuit. In certain states of the motor drive, the power switch circuit can couple either the regulated voltage or the supply voltage to the level shift circuit.

### CLAIM OF PRIORITY

This application claims the benefit of priority under 35 U.S.C. 119 to Weiming Sun et al., Chinese Patent Application Number, 201210055777.9, filed Feb. 28, 2012, which is hereby incorporated by reference herein in its entirety.

### OVERVIEW

This document discusses, among other things, apparatus and methods for a motor drive, such as a haptic motor drive. In an example, a motor drive can include a low dropout (LDO) regulator configured to receive a supply voltage and to provide a regulated voltage, a power switch circuit configured to receive the supply voltage and to receive the regulated voltage from the LDO regulator, and a level shift circuit configured to receive power from the power switch circuit, to receive an input signal, and to provide an output signal to a a voltage difference generating circuit based on the input signal and the power from the power switch circuit. In certain states of the motor drive, the power switch circuit can couple either the regulated voltage or the supply voltage to the level shift circuit.

This overview is intended to provide a general overview of subject matter of the present patent application. It is not intended to provide an exclusive or exhaustive explanation of the invention. The detailed description is included to provide further information about the present patent application.

### BACKGROUND

Haptic reproduction can refer to techniques that can provide a corresponding touch sensation when a finger touches a display, for example. The touch sensation can be produced by control of a certain physical effect prompt associated with, or part of, the display.

Haptic reproduction can provide physical feedback to electronic man-machine interactions. Haptic response in consumer electronics may improve user experience. For example, a physical touch response to a display pushbutton can provide a user with assurance that a button of a display was activated without seeing a visual indication or hearing an audio indication of the activation.

Haptic response systems can include a motor driving circuit to assist in providing physical feedback. FIG. 1 illustrates an existing motor driving circuit including a low-drop-out (LDO) regulator 11, a level shift circuit, overdrive control circuit, a first driver circuit including the amplifiers 12 and first signal path switch MN1, and a second driver circuit including bypass switch MP1. The driver can operate in a normal mode and in an overdrive mode. The LDO regulator supplies the motor drive power in both the normal mode and the overdrive mode. Both the overdrive mode and the normal mode can be required to supply large current to the motor, therefore signal path switches MP1 and MN1 are of a large size. In certain designs of this type, a bypass capacitor may be required to be connected to the LDO regulator 11, and also an additional external pin is may be needed to provide a large current to the output.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an existing motor drive system.

FIG. 2 illustrates generally a block diagram of an example motor drive circuit.

FIG. 3 illustrates generally a motor drive system including an example motor drive circuit.

FIG. 4 is a schematic view of the internal circuit of an LDO regulator according to the disclosure.

FIG. 5 is a schematic view of the internal circuit of a power switch circuit according to the disclosure.

FIG. 6 is a schematic view of the circuit structure for controlling an input signal of a level shift circuit using a control switch circuit according to the disclosure.

FIG. 7 is a schematic view of the internal circuit of the control switch circuit in FIG. 6.

FIG. 8 is a schematic view of the internal circuit of the level shift circuit according to the disclosure.

FIG. 9 is a schematic view of the internal circuit of a class AB amplifier according to the disclosure.

FIG. 10 is a flowchart for implementing a motor driving method according to the disclosure.

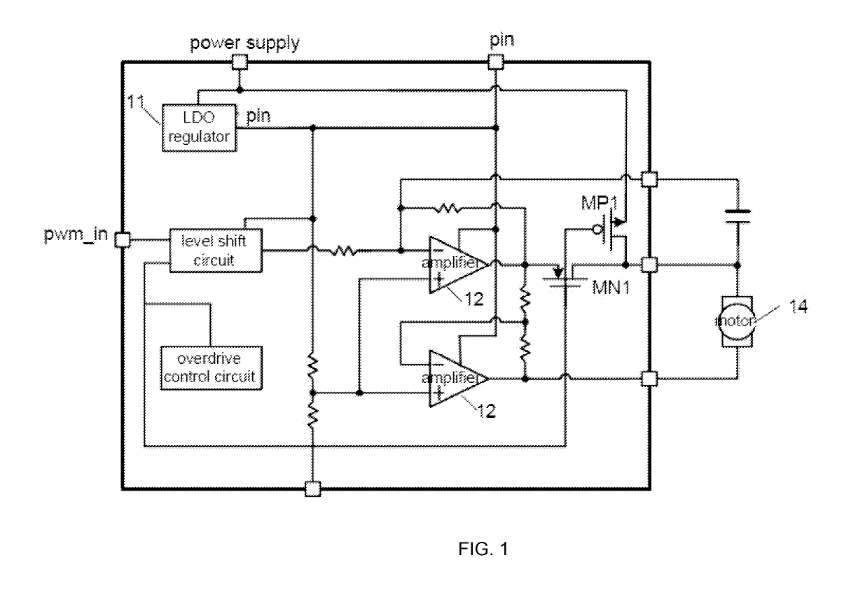

### DETAILED DESCRIPTION

The present inventors have recognized a motor drive circuit, such as for driving haptic motors to provide touch sensor feedback, that can provide normal and overdrive functionality with a reduced number of high-current devices, thus, allowing the motor drives to be smaller, less expensive, and more versatile for various applications. Such applications can include, but are not limited to, driving motors or actuators used to provide haptic responses.

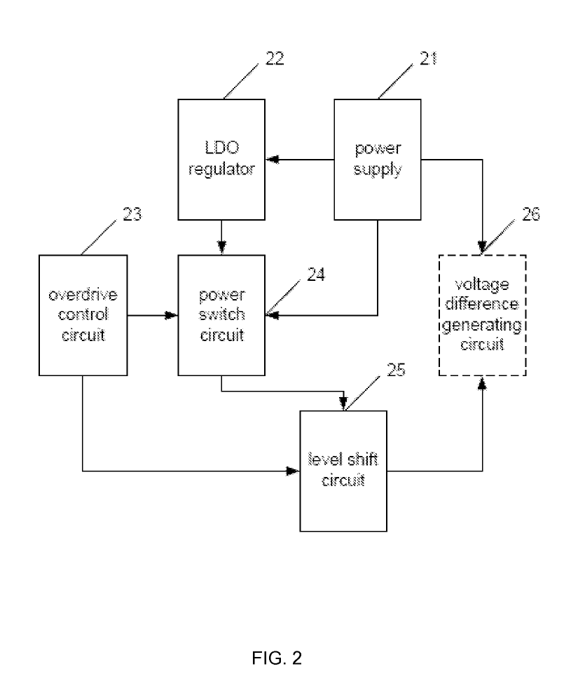

FIG. 2 illustrates generally a block diagram of an example motor drive circuit that can include a power supply 21, LDO regulator 22, overdrive control circuit 23, power switch circuit 24, and level shift circuit 25. In certain examples, the motor drive circuit can include a voltage difference generating circuit 26. In certain examples, the power supply 21 can supply power to the level shift circuit 25 via the power switch circuit 24 when a motor is in the overdrive state. In certain examples, the LDO regulator 22 can supply power for the level shift circuit 25 via the power switch circuit 24, when the motor is in the normal operating state.

In certain examples, the power switch circuit 24 can be coupled between the LDO regulator 22 and the level shift circuit, and between the power supply 21 and the level shift circuit 25. In some examples, the power switch circuit 24 can connect the power supply 21 to the level shift circuit 25 under the control of the overdrive control circuit 23 when the motor is in the overdrive state. In some examples, the power switch circuit 24 can connect the LDO regulator 22 to the level shift circuit 25 under the control of the overdrive control circuit 23 when the motor is in the normal operating state.

In certain examples, the level shift circuit 25 can shift a logic level of an input signal and provide the logic level shifted input signal to the voltage difference generating circuit 26 when the motor is in the normal operating state. In certain examples, the level shift circuit 25 can shift the logic level of a control signal from the overdrive control circuit 23 and provide the logic level shifted control signal to the voltage difference generating circuit 26 when the motor is in the overdrive state.

In certain examples, the voltage difference generating circuit 26 is configured to generate a voltage difference across the motor using a signal from the level shift circuit 25. In certain examples, the power supply 21 can supply power to the LDO regulator 22 and can supply power for amplifiers in the voltage difference generating circuit.

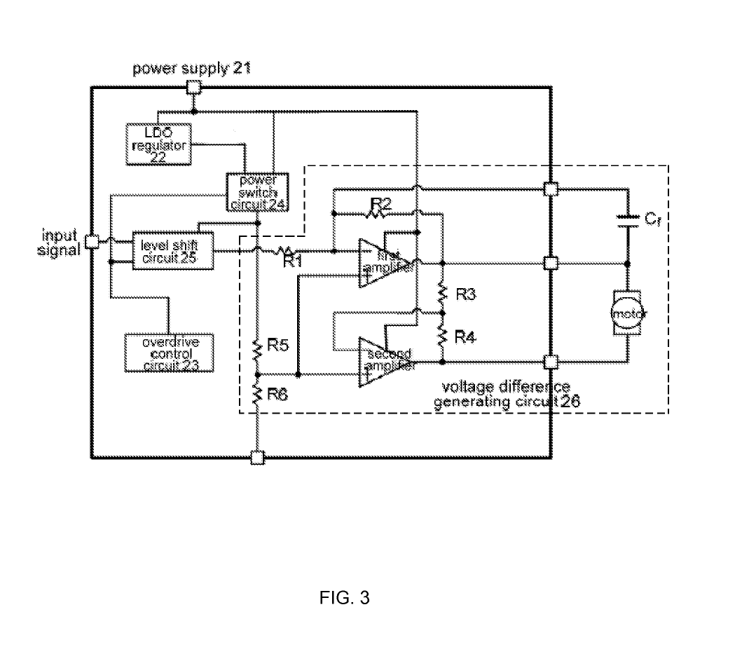

FIG. 3 illustrates generally a motor drive system including an example motor drive circuit. The motor drive system can include a motor and an example motor drive circuit. The motor, such as an Eccentric Rotating Mass (ERM) motor, can operate in a number of modes including a halt mode, a startup mode, a normal operating state and a stop mode. In general, the halt mode represents when the motor is not moving and is not being commanded to move. The start-up mode and the stop mode of the motor are modes that transition the motor between the halt mode and the normal operating state. The start-up and stop modes can correspond to overdrive modes of the motor drive circuit when the transition of the motor between the halt mode and normal operating state is done as fast as possible. In certain examples, a processor coupled to the motor drive circuit can determine when the motor should be in the normal operating state or the overdrive state, and the overdrive control circuit 23 can be notified of the determination.

In certain examples, the motor drive circuit can include a power supply terminal for receiving a supply voltage, an LDO regulator 22, an overdrive control circuit 23, a power switch circuit 24, a level shift circuit 25, and voltage difference generating circuit 26.

In certain examples, the voltage difference generating circuit 26 can include the motor. In certain examples, the voltage difference generating circuit 26 can include a feedback capacitor C_{f}.

In certain example, the voltage difference generating circuit 26 can include resistors R1 to R6. In some examples, a first resistor R1 can be connected to the level shift circuit 25 at one end, and to a negative terminal of a first amplifier at the other end. In some examples, a second resistor R2 can be connected at one end to the connecting point formed by the first resistor R1 and the first amplifier, and to the output of the first amplifier at the other end. In certain examples, a third resistor R3 can be connected at one end to the connecting point formed by the second resistor R2 and the first amplifier, and to one end of a fourth resistor R4 and a negative terminal of the second amplifier at the other end. In certain examples, the fourth resistor R4 can be connected at the other end to the output of the second amplifier. In some examples, a fifth resistor R5 can be connected at one end to the power switch circuit 24, and connected to the positive terminals of the first and second amplifiers and to one end of resistor R6 at the other end. In some examples, a sixth resistor R6 can be connected to the ground at the other end. In certain examples, the feedback capacitor C_{f} can be connected at one end to the connecting point formed by the first resistor R1 and the first amplifier, and to the connecting point formed by the second resistor R2 and the first amplifier at the other end. The motor can be connected at the positive terminal to the output of the second amplifier, and to the output of the first amplifier at the negative terminal.

In certain examples, the first and the second amplifiers, and resistors R3 and R4 can form a Bridge-Tied-Load (BTL) circuit. When the motor drive circuit operates, the voltages of the outputs of the first and second amplifiers form the voltage difference across the motor. In certain examples, both the first and the second amplifiers can be, but are not limited to, class AB amplifiers. In certain examples, the first resistors R1, second resistor R2 and feedback capacitor C_{f} can form a first order filter to filter a level-switched signal so as to obtain a direct current (DC) electric signal.

In certain examples, just before or when the motor is transitioning between the halt state and the normal operating state, the overdrive control circuit can switch the motor drive circuit into an overdrive mode. In certain examples, just before or when the motor is transitioning between the halt state and the normal operating state, the overdrive control circuit can provide an overdrive, or enable, signal to the power switch circuit. In certain examples, the power switch can connect the power supply 21 to the level shift circuit 25 during the overdrive mode in response to a first state of the overdrive signal. In certain examples, the power switch can connect the LDO regulator to the level shift circuit 25 during the normal operating state in response to a second state of the overdrive signal. In certain examples, the power supply voltage can be higher than the output voltage of the LDO regulator and the level shift circuit 25 can provide a higher level shifted circuit to the voltage difference generating circuit 26 when the power switch couples the power supply to the level shift circuit than when the power switch circuit couples the LDO regulator to the level shift circuit.

In certain examples, when the motor is in a halt state and has to come into operation promptly, namely, when the motor is in the overdrive state, the overdrive control circuit 23 can output an enable signal to the power switch circuit 24, such that the power switch circuit 24 connects the power supply 21 to the level shift circuit 25. Meanwhile, the overdrive control circuit 23 can output a high-level control signal to the level shift circuit 25. The level shift circuit can shift the logic level of the high-level control signal to a same logic level as the voltage provided by the power supply 21, and can transmit the level shifted signal to the voltage difference generating circuit 26. The voltage difference generating circuit 26 can use the signal from the level shift circuit 25 to generate a positive voltage difference across the motor, thereby bringing the motor into operation promptly, such that the motor enters the normal operating state.

In certain examples, after the motor enters in the normal operating state, the overdrive control circuit 23 can stop outputting the enable signal to the power switch circuit 24 and the power switch circuit 24 can disconnect the power supply from the level shift circuit 25 and can connect the LDO regulator 22 to the level shift circuit 25. The level shift circuit, in response to the enable signal of the overdrive control circuit 23, can shift the logic level of the input signal, i.e. the input Pulse Width Modulation (PWM) signal, to the same logic level as the output voltage of the LDO regulator 22, and can transmit the level shifted signal to the voltage difference generating circuit 26. The voltage difference generating circuit 26 can use the signal from the level shift circuit 25 to generate a different positive voltage difference across the motor. The voltage difference ranges between 0 and the output voltage of the LDO regulator 22, such that the motor operates as required.

When the motor is in the normal operating state and needs to halt operation promptly, namely, when the motor is in the overdrive state, the overdrive control circuit 23 can output the enable signal to the power switch circuit 24, and the power switch circuit can connect the power supply 21 to the level shift circuit 25 in response to the enable signal. The overdrive control circuit 23 can output a low-level control signal to the level shift circuit 25. The Level shift circuit 25 can shift the logic level of the low-level control signal to a same logic level as the low level within the motor driving circuit, and can transmit the level shifted signal to the voltage difference generating circuit 26. The voltage difference generating circuit 26 can use the signal from the level shift circuit 25 to generate a negative voltage difference across the motor, such that the motor can halt operation promptly.

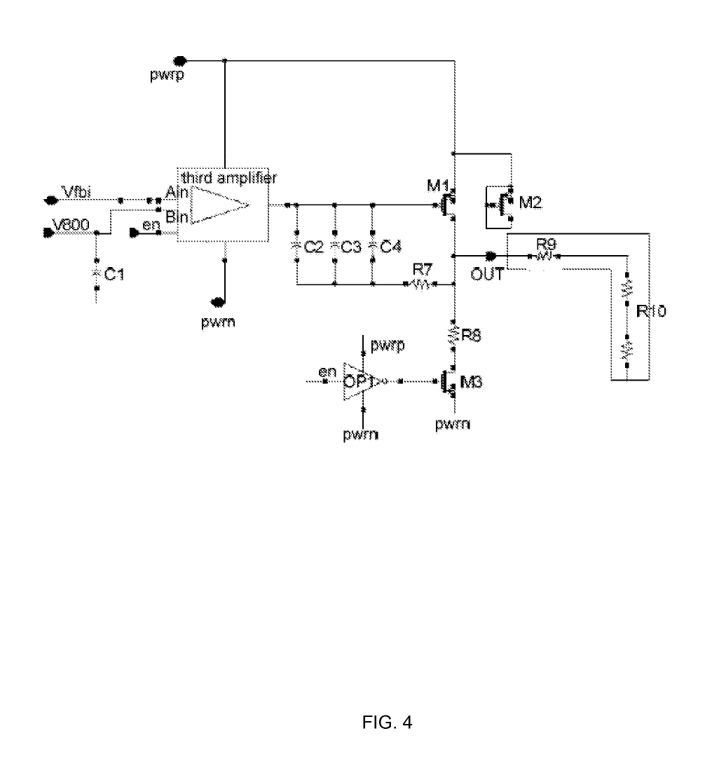

FIG. 4 is a schematic view of the internal circuit of an LDO regulator according to the disclosure. In certain examples, the LDO regulator 22 can include a third amplifier, capacitors C1 to C4, P-Channel Metal-Oxide-Semiconductor Field-Effect Transistors (PMOS) M1 and M2, an N-Channel Metal-Oxide-Semiconductor Field-Effect Transistor (NMOS) M3, a first inverter OP1, resistors R7 and R8, a variable resistor R9, and a resistor string R10. In some examples, the LDO regulator 22 can include a common power node (pwrp) that can be provided by the power supply 21, a common grounding point (pwrn), and an enable signal (en) of the motor driving circuit.

The operating principle of the LDO regulator 22 can include sampling voltage, such as a feedback voltage (Vfbi) of a resistor connected in series with the variable resistor R9 in the resistor string R10. Applying the feedback voltage (Vfbi) to the negative terminal (Ain) of the third amplifier. A reference voltage (V800) can be applied to the positive terminal (Bin) of the third amplifier. The difference between the voltage at the negative terminal (Ain) and the voltage at the positive terminal (Bin) can control, after being amplified by the third amplifier, the voltage difference of the PMOS Ml, thereby outputting a stable voltage at the output (OUT). When the LDO regulator 22 operates, it is possible to output different stable voltage values by regulating the resistance of the variable resistor (R9).

In certain examples, the capacitors C2 to C4 and the resistor R7 can serve for frequency compensation. In certain examples, the first inverter OP1, the resistor R8, and the NMOS M3 can serve to lower the level of the output OUT promptly when the LDO regulator does not operate.

In certain examples, such as the examples illustrated in FIGS. 2 to 4 that the LDO regulator 22 need only supply power to the level shift circuit 25 and resistors R5, R6, and is not required to output a large current to drive the motor. The implementation of the internal circuit of the LDO regulator 22 is relatively simple, such that manufacturing cost thereof can be reduced substantially compared to existing motor drives.

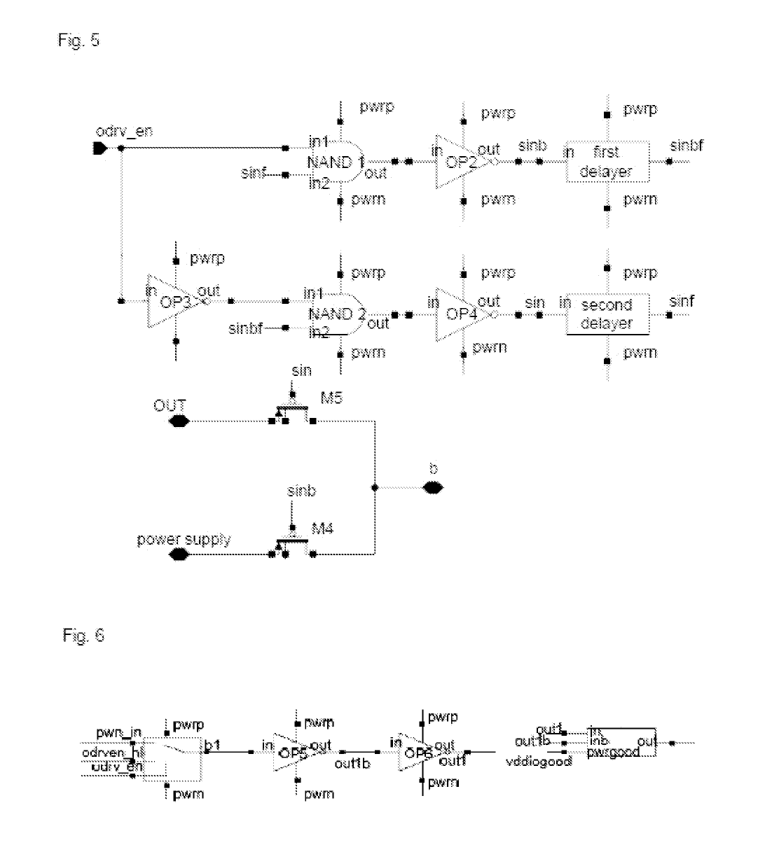

FIG. 5 is a schematic view of the internal circuit of a power switch circuit according to the disclosure. In certain examples, the power switch circuit 24 can include a Break Before Make (BBM) circuit, a PMOS M4, and a PMOS M5. In certain examples, the internal circuit of the BBM circuit can include a first NOT-AND gate NAND 1, a second inverter OP2, a first delayer, a third inverter OP3, a second NOT-AND gate NAND 2, a fourth inverter OP4, and a second delayer. Both the first input in1 of the first NOT-AND gate NAND 1 and the input in of the third inverter OP3 are connected to the enable (odrv_en) output of the overdrive control circuit 23. The second input in2 of the first NOT-AND gate NAND 1 is connected to the output signal (sinf) of the second delayer, and the output (out) can be connected to the input in of the second inverter OP2. The output (out) of the second inverter OP2 can be connected to the input (in) of the first delayer. The first input (in1) of the second NOT-AND gate NAND 2 can be connected to the output (out) of the third inverter OP3. The second input (in2) can be connected to the output signal (sinbf) of the first delayer, and the output (out) can be connected to the input (in) of the fourth inverter OP4. The output (out) of the fourth inverter OP4 can be connected to the input (in) of the second delayer. In certain examples, the output signal (sinb) of the second inverter OP2 can be connected to the gate of the PMOS M4. The source of the PMOS M4 can be connected to the power supply 21. The drains of the PMOS M4 and PMOS M5 can form an output (b), and the output signal (sin) of the fourth inverter OP4 can be connected to the gate of the PMOS M5, the source of the PMOS M5, and the output (OUT) of the LDO regulator 22. Note the common power node (pwrp), and the common grounding point (pwrn).

As shown in FIG. 5, when the motor is in the overdrive state, the overdrive control circuit 23 can output the enable signal (odrv_en) to the power switch circuit 24, in which case the output signal (sin) of the fourth inverter OP4 can switch off the PMOS M5 first. Then the output signal (sinb) of the second inverter OP can switch on the PMOS M4. When the motor is in the normal operating state, the overdrive control circuit 23 can stop outputting the enable signal (odrv_en) to the power switch circuit 24, in which case the output signal of the second inverter OP2 which is inversed to (sinb) can switch off the PMOS M4 first, then the output signal (sin) of the fourth inverter OP can switch on the PMOS M5.

In certain examples, the BBM circuit can serve to avoid the occurrence of simultaneous switch-on of the PMOS M4 and the PMOS M5. For example, in the case that the PMOS M4 is switched on and the PMOS M5 is switched off, when the PMOS M5 needs to be switched on, the BBM circuit can switch off the PMOS M4 first, and then switch on the PMOS M5. Accordingly, in the case that the PMOS M5 is switched on and the PMOS M4 is switched off, when the PMOS M4 needs to be switched on, the BBM circuit can switch off the PMOS M5 first, and then switch on the PMOS M4.

As the time length for the power switch circuit 24 to perform switching is of nanosecond (ns) order, generally speaking, little or no impact will be brought upon other devices that are operating in the motor driving circuit (such as the motor and the level shift circuit 25) at the moment the power switch circuit 24 switches. In certain applications, a bulk capacitor can be added at the output of the power switch circuit 24, to ensure that the power switch circuit 24 does not impact other devices operating in the motor driving circuit at the moment of switching.

In certain applications, when the motor is in the overdrive state, the input signal of the level shift circuit 25 can be the control signal from the overdrive control circuit 23. When the motor is in the normal operating state, the input signal of the level shift circuit 25 can be the input signal (pwn_in). As shown in FIG. 6, it is possible to arrange a control switch circuit between the level shift circuit 25 and the overdrive control circuit 23, and use the fifth inverter OP5 and the sixth inverter OP6 to perform shaping processing on the signal output by the control switch circuit.

FIG. 6 is a schematic view of the circuit structure for controlling an input signal of a level shift circuit using a control switch circuit according to the disclosure. In certain examples, the common power node (pwrp) can be supplied by a CPU. When the motor is in the overdrive state, the overdrive control circuit 23 can output the enable signal (odrv_en) to the control switch circuit, such that the input signal of the level shift circuit 25 is the control signal (odrven_hl) from the overdrive control circuit 23. When the motor is in the normal operating state, the overdrive control circuit 23 can stop outputting the enable signal (odrv_en) to the control switch circuit, such that the input signal of the level shift circuit 25 is the input signal (pwn_in). The output (out) of the control switch circuit can be connected to the input pin (in) of the fifth inverter OP5. The output (out) of the fifth inverter OP5 can be connected to the input pin (in) of the sixth inverter OP6. The output signal (out1) of the output (out) of the sixth inverter OP6 can be connected to the input pin (in) of the level shift circuit 25. The output signal (out1b) of the fifth inverter OP5 can be connected to the inverting input pin (inb) of the level shift circuit 25. The input goodness signal (vddiogood) can be connected to the input goodness pin (pwrgood) of the level shift circuit 25.

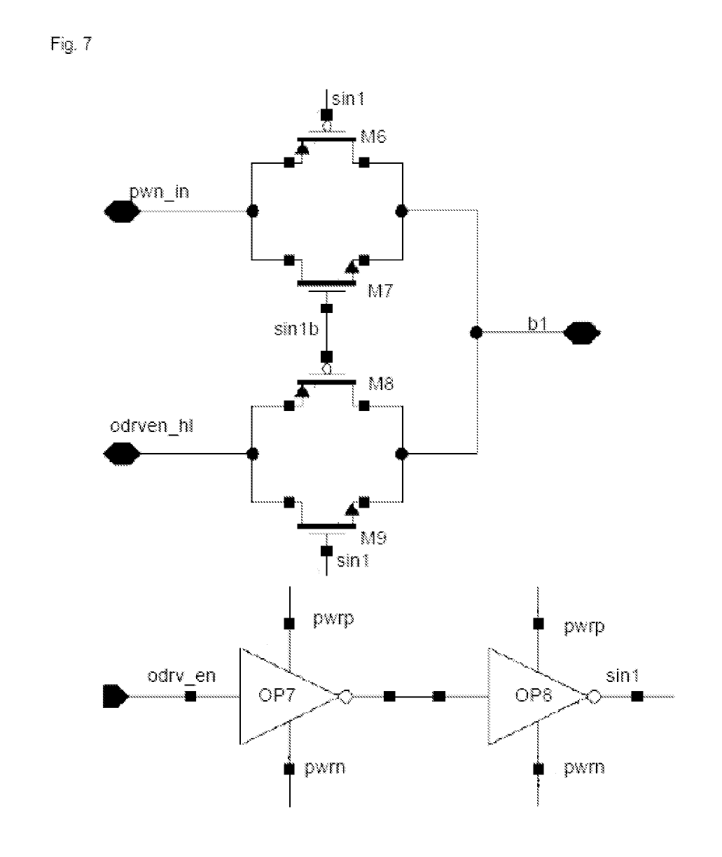

FIG. 7 is a schematic view of the internal circuit of the example control switch circuit of FIG. 6. In certain examples, the enable signal (odrv_en) output by the overdrive control circuit 23 can switch both the NMOS M9 and the PMOS M8 on, and can switch both the PMOS M6 and the NMOS M7 off, such that the output (b1) outputs the control signal (odrven_hl) from the overdrive control circuit 23. When the motor is in the normal operating state, the overdrive control circuit 23 can stop outputting the enable signal (odrv_en), such that both the PMOS M6 and the NMOS M7 are switched on, both the NMOS M9 and the PMOS M8 are switched off, and the output (b1) outputs the input signal (pwn_in).

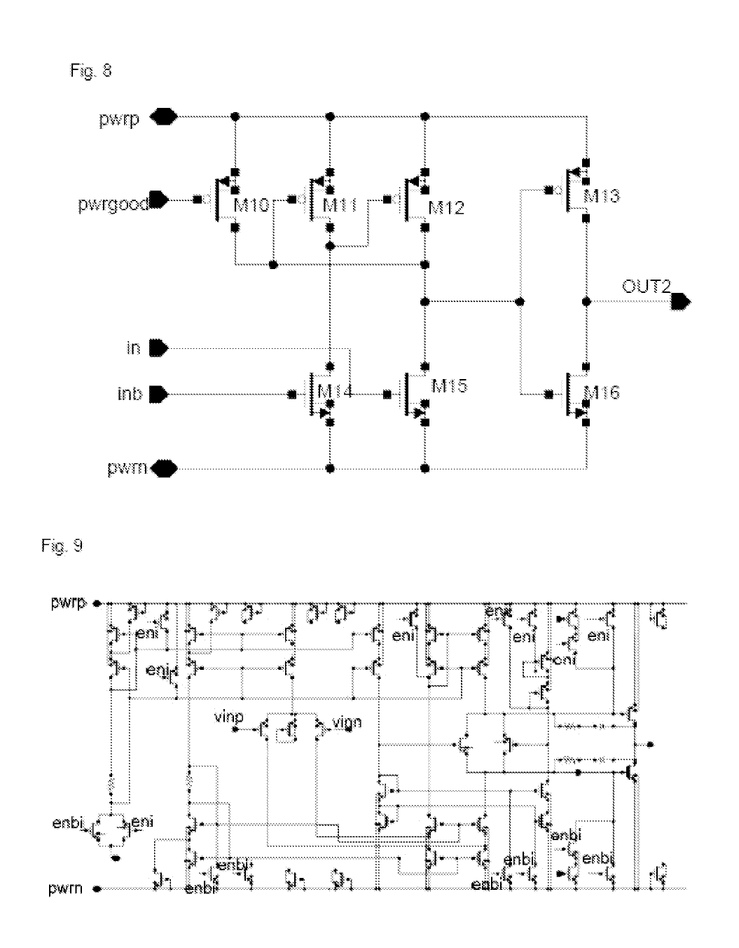

FIG. 8 is a schematic view of the internal circuit of an example level shift circuit according to the disclosure. When the motor is in the normal operating state, a high level signal can occur at the input pin (in), a low level signal can occur at the inverting input pin (inb), a high level signal can occur at the input goodness pin (pwrgood), in which case the PMOS M11, the PMOS M13, and the NMOS M15 are all switched on, the PMOS M10, the PMOS M12, the NMOS M14, and the NMOS M16 are all switched off, and the output (OUT2) can output the same high level signal as the logic level received at the supply voltage input (pwrp). When the motor is in the overdrive state and the control signal output by the overdrive control circuit 23 can be a high level signal, a high level signal can occur at the input pin (in), a low level signal can occur at the inverting input pin (inb), and a high level signal can occur at the input goodness pin (pwrgood), in which case the PMOS M11, the PMOS M13, and the NMOS M15 are all switched on, and the PMOS M10, the PMOS M12, the NMOS M14, and the NMOS M16 are all switched off, and the output (OUT2) can output the same high level signal as the logic level provided at the supply voltage input (pwrp). When the motor is in the overdrive state and the control signal output by the overdrive control circuit 23 is a low level signal, a low level signal can occur at the input pin (in), a high level signal can occur at the inverting input pin (inb), and a low level signal can occur at the input goodness pin (pwrgood), in which case the PMOS M10, the PMOS M12, the NMOS M14, and the NMOS M16 are all switched on, and the PMOS M11 and the NMOS M15 are all switched off, and the output (OUT2) can output the same low level signal as the logic low level inside the motor driving circuit.

FIG. 9 is a schematic view of the internal circuit of an example class AB amplifier according to the disclosure. In certain examples, such as the example illustrated in FIG. 9, it is possible to form the class AB amplifier by connecting 33 PMOSs, 25 NMOSs, 4 resistors, and 2 capacitors. The example amplifier can receive power from a power supply, such as the power supply 21 at a power node (pwrp) and a grounding point (pwrn). The class AB amplifier can include a positive terminal (vinp) and a negative terminal (vinn). The amplifier can include an enable input for receiving an enable signal (eni). In certain examples, the amplifier can receive an enable signal (eni) and a complimentary enable signal (enib). In certain examples the enable signal (eni) can be formed by shaping the enable signal of the motor driving circuit through two inverters. In certain examples, the complementary enable signal (enbi) can be formed by reversing the enable signal of the motor driving circuit through one inverter.

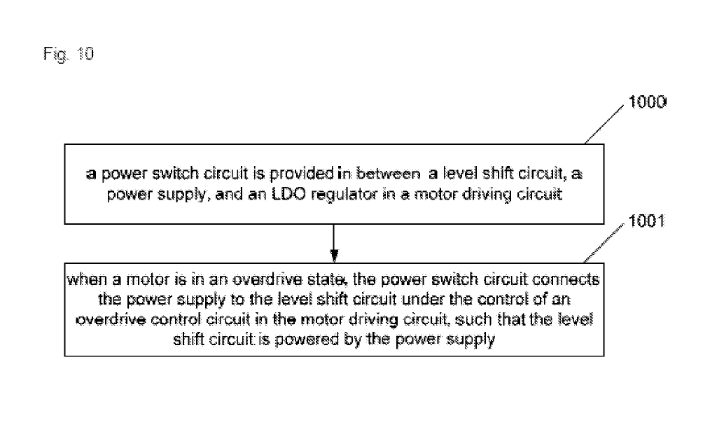

FIG. 10 is a flowchart for implementing an example motor driving method according to the disclosure.

As shown in FIG. 10, the method can include at 1000, providing a power switch circuit in between a level shift circuit, a power supply, and an LDO regulator of a motor driving circuit. In certain examples, the power supply can be configured to supply power for an amplifier in a voltage difference generating circuit in the motor driving circuit. At 1001, when a motor is in the overdrive state, the power switch circuit can connect the power supply to the level shift circuit under the control of an overdrive control circuit in the motor driving circuit, such that the level shift circuit is powered by the power supply.

In certain examples, when a motor is in the overdrive state, the power switch circuit connects the power supply to the level shift circuit under the control of the overdrive control circuit, the level shift circuit is powered by the power supply, and accordingly, the voltage difference generating circuit generates a voltage difference across the motor based on a control signal of which a level is shifted by the level shift circuit.

In certain examples, when the motor is in the normal operating state, the power switch circuit connects the LDO regulator to the level shift circuit under the control of the overdrive control circuit, such that the level shift circuit is powered by the LDO regulator. In some examples, when the motor is in the normal operating state, the power switch circuit connects the LDO regulator to the level shift circuit under the control of the overdrive control circuit, such that the level shift circuit is powered by the LDO regulator, and accordingly, the voltage difference generating circuit generates a voltage difference across the motor based on an input signal of which the level is shifted by the level shift circuit.

In certain examples, the power switch circuit connects the power supply to the level shift circuit under the control of an overdrive control circuit of the motor driving circuit includes: when the overdrive control circuit outputs an enable signal to the power switch circuit, the power switch circuit connects the power supply to the level shift circuit, such that the level shift circuit is powered by the power supply.

In certain examples, the power switch circuit connects the LDO regulator to the level shift circuit under the control of the overdrive control circuit, and supplying, by the LDO regulator includes: when the overdrive control circuit stops outputting the enable signal to the power switch circuit, the power switch circuit connects the LDO regulator to the level shift circuit, such that the level shift circuit is powered by the LDO regulator.

Based on the motor driving circuit shown in FIG. 2, the disclosure further provides a touch apparatus including a touch screen and an example motor driving circuit. Based on the aforementioned touch apparatus, the disclosure further provides an electronic device including a motherboard, a housing, and a touch apparatus including a touch screen and an example motor driving circuit. The electronic equipment can include, but is not limited to, a cellphone, a pad or tablet computer, a notebook, and the like.

### Additional Notes

In Example 1, a motor drive circuit can include a low dropout (LDO) regulator configured to receive a supply voltage and to provide a regulated voltage, a power switch circuit configured to receive the supply voltage and to receive the regulated voltage from the LDO regulator, and a level shift circuit configured to receive power from the power switch circuit, to receive an input signal, and to provide an output signal to a a voltage difference generating circuit based on the input signal and the power from the power switch circuit. The power switch circuit can include a first state and a second state. The power switch circuit can be configured to provide the regulated voltage from the LDO regulator to the level shift circuit in the first state. The power switch circuit can be configured to provide the supply voltage to the level shift circuit in the second state.

In Example 2, the example motor drive circuit of claim 1 optionally includes an overdrive circuit configured to control the state of the power switch.

In Example 3, the motor drive circuit of any one or more of Examples 1-2 optionally includes the voltage difference generating circuit, the voltage difference generating circuit configured to receive power from the supply voltage and to provide at least a portion of the power to a motor.

In Example 4, the voltage difference generating circuit of any one or more of Examples 1-3 optionally is configured to provide the at least a portion of the power using the output signal of the level shift circuit.

In Example 5, the voltage difference generating circuit of any one or more of Examples 1-4 optionally includes an amplifier.

In Example 6, the voltage difference generating circuit of any one or more of Examples 1-5 optionally includes an AB amplifier.

In Example 7, an electronic device can include a touchscreen configured to provide an indication of a touch event associated with the touch screen, and a motor drive circuit configured to receive the indication and to provide a drive signal to a haptic actuator. The motor drive circuit can include a low dropout (LDO) regulator configured to receive a supply voltage and to provide a regulated voltage, a power switch circuit configured to receive the supply voltage and to receive the regulated voltage from the LDO regulator, and a level shift circuit configured to receive power from the power switch circuit, to receive an input signal, and to provide an output signal to a a voltage difference generating circuit based on the input signal and the power from the power switch circuit. The power switch circuit can include a first state and a second state. The power switch circuit can be configured to provide the regulated voltage from the LDO regulator to the level shift circuit in the first state. The power switch circuit can be configured to provide the supply voltage to the level shift circuit in the second state.

In Example 8, the electronic device of any one or more of Examples 1-7 optionally includes an overdrive circuit configured to control the state of the power switch, and the voltage difference generating circuit. The voltage difference generating circuit optionally is configured to receive power from the supply voltage and to provide at least a portion of the power to a motor and to provide the at least a portion of the power using the output signal of the level shift circuit.

In Example 9, the electronic device of any one or more of Examples 1-8 optionally includes the haptic actuator.

In Example 10, the haptic actuator of any one or more of Examples 1-9 optionally includes an eccentric rotating mass motor.

In Example 11, the electronic device of any one or more of Examples 1-10 optionally includes a wireless transceiver configured to communicate over a wireless network in response to the indication.

In Example 12, a method for driving a haptic motor can include receiving a drive command at a motor drive coupled to the haptic motor, coupling a level shift circuit to a supply voltage of the motor drive to initiate motion of the haptic motor in response to the drive command, and coupling the level shift circuit to a low drop-out regulator of the motor drive to maintain motion of the haptic motor.

In Example 13, the method of any one or more of Examples 1-11 optionally includes receiving a halt command at the motor drive, and coupling the level shift circuit to the supply voltage to stop the motion of the haptic drive in response to the halt command.

In Example 14, the receiving the drive command of any one or more of Examples 1-13 optionally includes receiving a high logic signal from an overdrive circuit of the motor drive at the level shift circuit, and providing a first voltage having a first polarity to the haptic motor, wherein the first voltage is near the supply voltage.

In Example 15, the receiving the drive command of any one or more of Examples 1-14 optionally includes receiving a pulse width modulated signal at the motor drive.

In Example 16, the receiving the halt command of any one or more of Examples 1-15 optionally includes receiving a low logic signal from the overdrive circuit at the level shift circuit, and providing the first voltage having a second polarity to the haptic motor, wherein the second polarity is opposite the first polarity.

In Example 17, the method of any one or more of Examples 1-16 optionally includes receiving an first indication of a first touch event from a touch control, providing the drive command in response to the first touch event using a processor coupled to the touch screen, receiving a second indication of a second touch event from the touch control, and providing the halt command in response to the second indication using the processor.

In example 18, the touch control of any one or more of Examples 1-17 optionally includes a touch screen.

In Example 19, the method of any one or more of Examples 1-13 optionally includes receiving a first indication of a first touch event from a pushbutton and providing the drive command in response to the first touch event using a processor coupled to the touch screen.

In Example 20, a touch screen includes the pushbutton of any one or more of Examples 1-19.

Example 21 can include, or can optionally be combined with any portion or combination of any portions of any one or more of Examples 1 through 20 to include, subject matter that can include means for performing any one or more of the functions of Examples 1 through 20, or a machine-readable medium including instructions that, when performed by a machine, cause the machine to perform any one or more of the functions of Examples 1 through 20.

The above detailed description includes references to the accompanying drawings, which form a part of the detailed description. The drawings show, by way of illustration, specific embodiments in which the invention can be practiced. These embodiments are also referred to herein as “examples.” All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

What is claimed is:

1. A motor drive circuit, comprising:
a low dropout (LDO) regulator configured to receive a supply voltage and to provide a regulated voltage;
a power switch circuit configured to receive the supply voltage and to receive the regulated voltage from the LDO regulator; and
a level shift circuit configured to receive power from the power switch circuit, to receive an input signal, and to provide an output signal to a a voltage difference generating circuit based on the input signal and the power from the power switch circuit,
wherein the power switch circuit includes a first state and a second state,
wherein the power switch circuit is configured to provide the regulated voltage from the LDO regulator to the level shift circuit in the first state, and
wherein the power switch circuit is configured to provide the supply voltage to the level shift circuit in the second state.

2. The motor drive circuit of claim 1, including an overdrive circuit configured to control the state of the power switch.

3. The motor drive circuit of claim 1, including the voltage difference generating circuit, the voltage difference generating circuit configured to receive power from the supply voltage and to provide at least a portion of the power to a motor.

4. The motor drive circuit of claim 3, wherein the voltage difference generating circuit is configured to provide the at least a portion of the power using the output signal of the level shift circuit.

5. The motor drive circuit of claim 3, wherein the voltage difference generating circuit includes an amplifier.

6. The motor drive of claim 3, wherein the voltage difference generating circuit includes an AB amplifier.

7. An electronic device comprising:
a touchscreen configured to provide an indication of a touch event associated with the touch screen; and
a motor drive circuit configured to receive the indication and to provide a drive signal to a haptic actuator, the motor drive circuit including;
a low dropout (LDO) regulator configured to receive a supply voltage and to provide a regulated voltage;
a power switch circuit configured to receive the supply voltage and to receive the regulated voltage from the LDO regulator; and
a level shift circuit configured to receive power from the power switch circuit, to receive an input signal, and to provide an output signal to a a voltage difference generating circuit based on the input signal and the power from the power switch circuit,
wherein the power switch circuit includes a first state and a second state,
wherein the power switch circuit is configured to provide the regulated voltage from the LDO regulator to the level shift circuit in the first state, and
wherein the power switch circuit is configured to provide the supply voltage to the level shift circuit in the second state.

8. The electronic device of claim 7, including an overdrive circuit configured to control the state of the power switch; and
the voltage difference generating circuit, the voltage difference generating circuit configured to receive power from the supply voltage and to provide at least a portion of the power to a motor; and to provide the at least a portion of the power using the output signal of the level shift circuit.

9. The electronic device of claim 8, including the haptic actuator;

10. The electronic device of claim 9, wherein the haptic actuator includes an eccentric rotating mass motor.

11. The electronic device of claim 7, including a wireless transceiver configured to communicate over a wireless network in response to the indication.

12. A method for driving a haptic motor, the method comprising;
receiving a drive command at a motor drive coupled to the haptic motor;
coupling a level shift circuit to a supply voltage of the motor drive to initiate motion of the haptic motor in response to the drive command; and
coupling the level shift circuit to a low drop-out regulator of the motor drive to maintain motion of the haptic motor.

13. The method of claim 12, including:
receiving a halt command at the motor drive; and
coupling the level shift circuit to the supply voltage to stop the motion of the haptic drive.

14. The method of claim 13, wherein receiving the drive command includes receiving a high logic signal from an overdrive circuit of the motor drive at the level shift circuit; and
providing a first voltage having a first polarity to the haptic motor, wherein the first voltage is near the supply voltage.

15. The method of claim 14, wherein receiving the drive command includes receiving a pulse width modulated signal at the motor drive.

16. The method of claim 14, wherein receiving the halt command includes receiving a low logic signal from the overdrive circuit at the level shift circuit; and
providing the first voltage having a second polarity to the haptic motor, wherein the second polarity is opposite the first polarity.

17. The method of claim 13, including:
receiving a first indication of a first touch event from a touch control;
providing the drive command in response to the first touch event using a processor coupled to the touch screen;
receiving an second indication of a second touch event from the touch control; and
providing the halt command in response to the second indication using the processor.

18. The method of claim 17 wherein the touch control includes a touch screen.

19. The method of claim 13, including:
receiving a first indication of a first touch event from a pushbutton; and
providing the drive command in response to the first touch event using a processor coupled to the touch screen.

20. The method of claim 17 wherein a touch screen includes the pushbutton.
